(19) United States
(12) Patent Application Publication
(10) Pub. No.: US 2007/0050527 A1
(43) Pub. Date: Mar. 1, 2007

(54) SYNCHRONIZATION METHOD FOR A MULTI-PROCESSOR SYSTEM AND THE APPARATUS THEREOF

(76) Inventor: Cheng-Ming Tuan, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,447

(22) Filed: Dec. 28, 2005

(30) Foreign Application Priority Data
Aug. 26, 2005 (TW) 94129192

(51) Int. Cl. G06F 12/00; G06F 12/14

(52) U.S. Cl. 710/200

(57) ABSTRACT

A synchronous method for a multi-processor system and the apparatus thereof are provided. The method comprises the following steps. First, a request for acquiring a spinlock from a processor is received and then the status of the spinlock is returned to the processor. If the spinlock is in an unlock state, the spinlock is changed to a locked state. If the spinlock is already in the locked state, the clock signal to the processor is suspended so that the processor is suspended and the suspended processor is added to a queue. Then, when a request for releasing the spinlock is received from a processor, the spinlock is changed to the unlocked state. Finally, if there are other processors waiting in the queue, one of the processors is selected from the queue according to a predetermined policy and the clock signal of the selected processor is resumed.

### CROSS-REFERENCE TO RELATED APPLICATION

This application claims the priority benefit of Taiwan application serial no. 94129192, filed on Aug. 26, 2005. All disclosure of the Taiwan application is incorporated herein by reference.

### BACKGROUND OF THE INVENTION

1. Field of the Invention

The present invention relates to a synchronous method and apparatus for a multi-processor system. More particularly, the present invention relates to a synchronous method and an apparatus that use spinlocks.

2. Description of the Related Art

In a multi-processor system, spinlocks are indispensable means of synchronization. If the programs executed on different processors are allowed to modify a shared piece of the data structure, data errors will proliferate. Through the synchronous mechanism, the processor which successfully acquires the spinlock of a data structure has the authority to modify the shared data structure. In this way, the correctness of the information in a shared data structure can be ensured.

In general, the design of the spinlocks will affect the performance of a multi-processor system. In the conventional method, the spinlock uses one of the addresses in a memory. The spinlock is obtained through an atomic operation such as a test-and-set, load-link, store-condition and a software program. If the acquisition of the spinlock is successful, the modification of the shared data structure is allowed. However, if the acquisition of the spinlock is unsuccessful, the processor will enter into an eternal loop forever inspecting the state of the spinlock constantly. When a large number of processors are in loops inspecting the spinlock constantly, a lot of bus bandwidth and memory bandwidth are held up, which leads to a significant drop about system performance.

### SUMMARY OF THE INVENTION

The first objective of the present invention is to provide a synchronous method for a multi-processor system that can save a lot of bus bandwidth and memory bandwidth.

The second objective of the present invention is to provide a synchronous apparatus for a multi-processor system that does not need an atomic operation to synchronize a plurality of processors, saves electrical power and improves system performance.

To achieve the above and other advantages and in accordance with the purpose of the invention, as embodied and broadly described herein, the invention provides a synchronous method for a multi-processor system. The synchronous method is characterized in that the clock signal of the processor is suspended to suspend its operation in the period of time after a failed attempt of the processor to acquire a spinlock and before the same processor successfully acquires the spinlock.

In the aforementioned synchronous method for a multi-processor system, an embodiment includes the following steps. First, a synchronous apparatus receives a spinlock request from a processor and then returns the status of the spinlock to the processor. If the spinlock is in an unlocked state, the spinlock is changed to a locked state. If the spinlock is in a locked state, the operation of the processor is suspended and the processor is added to a queue. Then, a synchronous apparatus receives a request for releasing the spinlock from a processor and changes the spinlock to an unlocked state. Finally, if there are other processors waiting in the queue, one of the processors is selected from the queue according to a predetermined policy and the operation of the selected processor is resumed.

Based on another point of view, the present invention also provides a synchronous apparatus for a multi-processor system. The synchronous apparatus comprises a spinlock controller and a clock generator. The spinlock controller receives a plurality of acquisition and releasing requests from a number of processors. The clock generator provides a plurality of clock signals to the processors. The clock generator also follows the instructions from the spinlock controller to suspend the clock signal of a particular processor so that the operation of the particular processor is suspended within a period from the time after a request for acquiring a spinlock fails to the time before the acquisition of the spinlock is granted.

According to the preferred embodiment of the present invention, the processor is temporarily suspended after a request for acquiring a spinlock fails. Then, the operation of the processor is resumed after a waiting period just before the acquisition of the spinlock is successful. During the temporary suspension, it is not necessary for the processor to poll the memory repeatedly to find the state of the spinlock like other prior techniques. Thus, considerable bus bandwidth and memory bandwidth can be saved from the system. Power consumption can be reduced and performance of the system can be improved. Furthermore, the present invention also uses a spinlock controller to manage all spinlock requests from processors in a central location. Hence, the synchronization of a multi-processor system can be achieved without using any atomic operation.

At present, most portable multi-media electronic products deploy a single chip multi-processor system to provide higher performance with lower power consumption. The present invention is particularly suitable for a single chip multi-processor system because only a few additional logic circuits are required in the single chip system.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1 and 2 are flowcharts showing the steps in the multi-processor system synchronous method according to one embodiment of the present invention.

FIG. 3 is a block diagram of a synchronous apparatus for a multi-processor system according to one embodiment of the present invention.

FIGS. 4 to 6 are block diagrams showing the configuration of three possible spinlock controllers according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

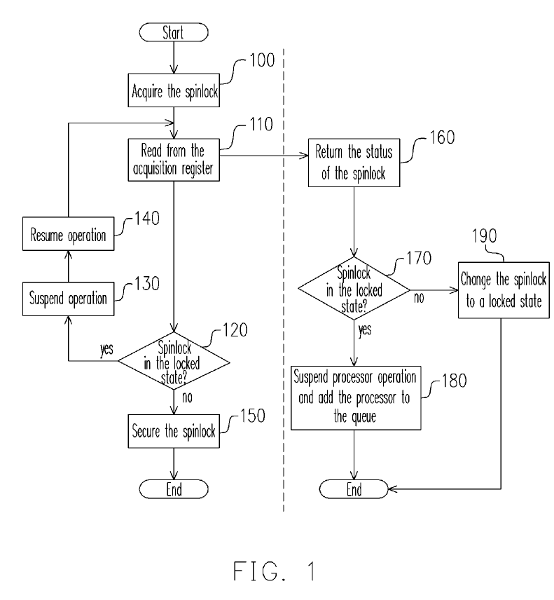

FIG. 1 is a flowchart showing part of the steps in the multi-processor system synchronous method according to one embodiment of the present invention. As shown in FIG. 1, the flow can be roughly divided into two parts. The steps on the left side of the vertical dash line mainly deals with the acquisition of spinlock by a processor. The steps on the right side of the vertical dash line are at the core of the synchronous method. In other words, the steps on the right side mainly deals with receiving requests for spinlocks and processing those request, the main operations of a synchronous apparatus.

First, in step 100, a processor attempts to obtain a spinlock. In step 110, the processor reads the status of the spinlock through an acquisition register provided by the synchronous apparatus. This reading operation is equivalent to a spinlock request issued to the synchronous apparatus. In step 160, the status of the spinlock returns to the requesting processor after the synchronous apparatus receives the request.

Then, the synchronous apparatus checks the spinlock status in step 170, and the processor checks the spinlock status in step 120. If the spinlock status is in an unlocked state indicating the spinlock is not occupied, the synchronous apparatus will change the status of the spinlock to a locked state in step 1 90. On the other hand, the processor successfully acquires the spinlock in step 150, owns the spinlock and is free to modify the shared data structure.

On the contrary, when the synchronous apparatus receives a request from the processor, the current request will fail if the spinlock is in the locked state indicating the spinlock has already been occupied by another processor. At this moment, the synchronous apparatus will temporarily suspend the processor whose request for the spinlock fails in step 180 and then add the processor to a waiting queue. In the present embodiment, the synchronous apparatus suspends the operation of the processor by means of suspending the clock signal of the processor.

When the processor discovers that the spinlock is in a locked state in step 120, it will back track to step 110 and attempt to put up another requesting for the spinlock again in an unending loop. However, the synchronous apparatus rapidly suspends such operation in step 130. At the end of the waiting in the queue, the operation of the processor is resumed by the synchronous apparatus in step 140. Thereafter, the processor will return to step 110 again and attempt to acquire the spinlock. If there is not competition from other processor, the requesting processor may occupy the spinlock.

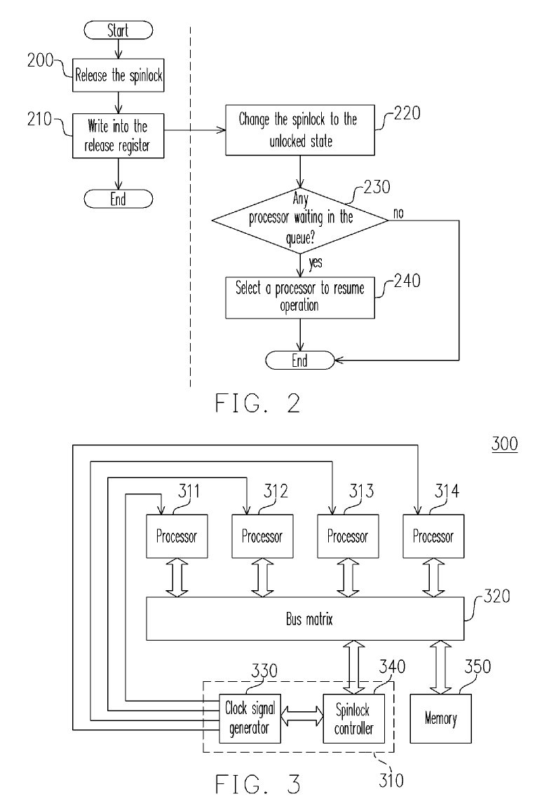

FIG. 2 is a flowchart showing another part of the steps in the multi-processor system synchronous method according to one embodiment of the present invention. Similarly, the steps in FIG. 2 can be roughly divided into two parts. The steps on the left side of the vertical dash line deals with the releasing of the spinlock by a processor. The steps on the right side of the dash line deals with the receiving and the processing of requests from the processors, which is the domain of operation of the synchronous apparatus.

First, the processor starts to release the spinlock in step 200. In step 210, a particular value is written to a release register provided by the synchronous apparatus. In the present embodiment, this write operation is equivalent to a releasing request issued to the synchronous apparatus. Then, in step 220, the synchronous apparatus receives the request from the processor and then changes the status of the spinlock from a locked state to an unlocked state. In step 230, the synchronous apparatus checks if there are any other processors still waiting in the queue requesting for the spinlock. If there is, the synchronous apparatus will select one of the processors from the queue according to a predetermined policy in step 240 and resume the operation of the selected processor. In the present embodiment, the predetermined policy may be a first-in-first-out policy, meaning that the processors entering into the waiting queue first is selected first. Alternatively, a predetermined priority may be used to determine that the processor having the highest priority is selected first. Any other conventional priority or selection schemes may be used as well.

FIG. 3 is a block diagram of a synchronous apparatus for a multi-processor system 300 according to one embodiment of the present invention. As shown in FIG. 3, the multi-processor system 300 comprises a plurality of processors 311˜314, a bus matrix 320, a memory 350 and a synchronous apparatus 310 according to the present invention.

All the steps mentioned in the right side of the dash line in FIGS. 1 and 2 are executed through the synchronous apparatus 310. The synchronous apparatus 310 includes a spinlock controller 340 and a clock signal generator 330. The spinlock controller 340 receives requests for acquiring or releasing the spinlock from the processors 311˜314 through the bus matrix 320 and processes those requests accordingly. The clock signal generator 330 provides clock signals for the processors 311˜314. The clock signal generator 330 is also responsible for suspending the clock signal of a particular processor according to the instructions provided by the spinlock controller 340. As a result, the operation of the particular processor is suspended within a period from the time after a request for acquiring the spinlock fails to the time before the request is granted.

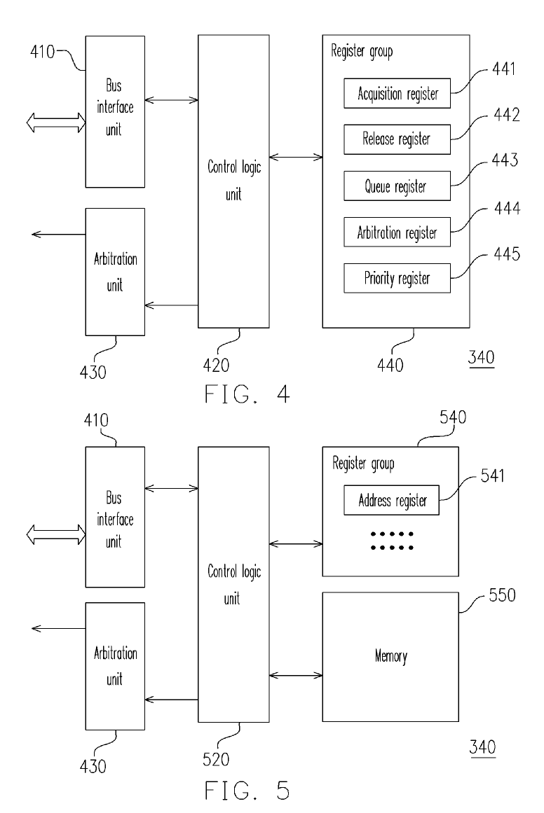

FIG. 4 is a block diagram showing the structure of a spinlock controller 340. The spinlock controller 340 comprises a bus interface unit 410, an arbitration unit 430, a control logic unit 420 and a register group 440. The bus interface unit 410 picks up the requests from the processors 311˜314 through the bus matrix 320. The control logic unit 420 receives the aforesaid request from the bus interface unit 410, processes those requests and maintains relevant information regarding the management of the spinlock in the meantime. If the operation of a particular processor needs to be suspended temporarily, the arbitration unit 430 will issue an instruction signal to the clock signal generator 330 to suspend the processor according to the instructions provided by the control logic unit 420.

In the present embodiment, the information related to the spinlock includes the status of the spinlock, the queue of processors waiting for the acquisition of the spinlock, and the predetermined policy for selecting a particular processor from the processors waiting in the queue. In the present embodiment, there are only two spinlock states, locked and unlocked. The predetermined policy determines which one of the processors in the queue to occupy the spinlock is selected first. In the present invention, the predetermined policy can be a first-in-first-out policy, a policy based on a predetermined priority setting or a policy based on other conventional schemes. If the selection is based on a predetermined priority scheme, then the priority may also be included in the related information of the spinlock.

In general, the related information of the spinlock can be stored in three ways. The first way is to store all the information inside registers. The second way is to store part of the information inside registers and part of the information inside a memory. The third way is to store all the information inside a memory. In FIG. 4, all the relevant information of the spinlock is stored inside registers.

The register group 440 in FIG. 4 is used for storing related information of the spinlock including an acquisition register 441, a release register 442, a queue register 443, an arbitration register 444 and a priority register 445. The acquisition register 441 stores the status of the spinlock. If a processor reads from the acquisition register 441, this action is regarded as issuing a request for acquiring the spinlock. If a processor writes any value to the release register 442, this action is regarded as issuing a request for releasing the spinlock. The queue register 443 stores the queue of processors waiting to acquire the spinlock. The arbitration register 444 stores the predetermined policy for selecting a processor from the queue. The priority register 445 stores the predetermined priority of the processors.

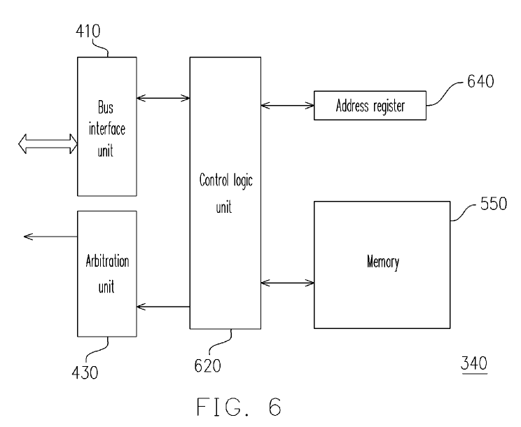

FIG. 5 is a block diagram showing the structure of a spinlock controller 340 having a second type of storage scheme for storing the spinlock-related data. As shown in FIG. 5, part of the spinlock-related data is stored inside a register group 540 and the remaining part of the spinlock-related data is stored inside a memory 550 connected to the control logic unit 520. The register group 540 includes an address register 541 for storing all the addresses in the memory 550 that hold the remaining part of the spinlock information inside the memory 550. Obviously, the register group 540 also includes other registers for holding information related to the register group 540. Because the control logic unit 520 obtains spinlock-related data inside the memory 550 through the address register 541, the memory address of the related data can be re-assigned or changed instantaneously by changing the content within the address register 541. Thus, the flexibility in application is improved.

Aside from using the built-in memory 550 inside a built-in spinlock controller 340, the scope of the present invention also includes using an external memory, for example, the system memory 350 in FIG. 3 to store the spinlock-related data. If an external memory is used, the control logic unit 520 will access the related data within the external memory through the bus matrix 320.

Finally, FIG. 6 is a block diagram showing the structure of a spinlock controller 340 having a third type of storage scheme for storing the spinlock-related data. As shown in FIG. 6, all the spinlock-related data is stored in the memory 550 connected to the control logic unit 620. The address register 640 is used for storing the addresses inside the memory 550 where the spinlock-related data are stored. Similarly, aside from the build-in memory, the related data can also be stored inside an external memory.

In summary, the present invention suspends the operation of a processor after a request from the processor for acquiring the spinlock fails. The operation of the processor is resumed at the end of a waiting period just before the acquisition of the spinlock is successful. In the suspension period, the processor will not incessantly read from the memory to find out the status of the spinlock and hence can save some bus bandwidth and memory bandwidth in the system. As a result, power can be saved and the performance of the system can be improved. Furthermore, the spinlock controller in the present invention can manage all the requests issued by processors at a central location. Therefore, multi-processor synchronization can be achieved without using any atomic operation.

At present, most portable multi-media electronic products deploy a single chip multi-processor system to provide higher performance with lower power consumption. The present invention is particularly suitable for a single chip multi- processor system because only a few additional logic circuits are required in the single chip system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A synchronous method for a multi-processor system, characterized by:
suspending the operation of a processor from the time after the failure of the processor to acquire a spinlock to the time before the processor successfully acquires the spinlock.

2. The synchronous method of claim 1, wherein the method further includes the following step:
suspending the clock signal to the processor so that the operation of the processor is suspended.

3. The synchronous method of claim 1, wherein the method further includes the following steps:
receiving a request for acquiring the spinlock from a processor and returning the status of the spinlock to the requesting processor;
if the spinlock is in an unlocked state, changing the spinlock state to a locked state;
if the spinlock is in a locked state, suspending the operation of the processor and adding the processor to a waiting queue;
receiving a request for releasing the spinlock from a processor and changing the spinlock state to a an unlocked state; and
if some processors are still waiting in the queue, selecting a processor from the queue according to a predetermined policy and resuming the operation of the selected processor.

4. The synchronous method of claim 3, wherein the predetermined policy is to resume the operation of the processor entering the queue first and waiting in line the longest.

5. The synchronous method of claim 3, wherein the predetermined policy is based on a predetermined priority for the processors and the processor having the highest priority is selected from the queue first.

6. A synchronous apparatus for a multi-processor system, comprising:
a spinlock controller for receiving and processing requests for acquiring and releasing a spinlock from a plurality of processors; and
a clock signal generator for providing a plurality of clock signals to the processors, and according to instructions provided by the spinlock controller, suspending the clock signal to a particular processor so that the operation of the processor is suspended in the time period after the processor fails to acquire a spinlock and before the processor successfully acquires the spinlock.

7. The synchronous apparatus of claim 6, wherein the spinlock controller comprises:
a bus interface unit for receiving the requests through a bus matrix;
a control logic unit for receiving the requests from the bus interface unit, processing the requests and maintaining all data related to the spinlock; and
an arbitration unit such that if a particular processor needs to be suspended, the arbitration unit transmits indicating signals to the clock signal generator according to the instructions provided by the control logic unit to suspended the operation of the processor.

8. The synchronous apparatus of claim 7, wherein the related data includes the status of the spinlock and the queue of processors waiting to acquire the spinlock.

9. The synchronous apparatus of claim 8, wherein the spinlock is either in a locked state or in an unlocked state.

10. The synchronous apparatus of claim 8, wherein the related data further includes a predetermined policy and the predetermined policy determines the selection of a processor in the queue having the priority to acquire the spinlock first.

11. The synchronous apparatus of claim 8, wherein the related data further includes a predetermined priority for the processors to acquire the spinlock.

12. The synchronous apparatus of claim 7, wherein the spinlock controller further includes a register group for storing the spinlock related data.

13. The synchronous apparatus of claim 12, wherein the register group further includes:
an acquisition register for storing the status of the spinlock and receiving the requests for acquiring the spinlock;
a releasing register for receiving the requests for releasing the spinlock; and
a queue register for storing all the processors waiting to acquire the spinlock.

14. The synchronous apparatus of claim 13, wherein the register group further includes an arbitration register for storing a predetermined policy, the predetermined policy determines the selection of a processor in the queue having the priority to acquire the spinlock first.

15. The synchronous apparatus of claim 13, wherein the register group further includes a priority register for storing a predetermined priority for the processors to acquire the spinlock.

16. The synchronous apparatus of claim 7, wherein the spinlock controller further comprises a register group for storing a part of the spinlock related data, a memory stores the remaining spinlock related data, and the register group includes an address register for storing the addresses in the memory where the remaining spinlock related data are stored.

17. The synchronous apparatus of claim 16, wherein the memory is either an internal memory included within the spinlock controller or is an independent external memory outside the spinlock controller.

18. The synchronous apparatus of claim 7, wherein the spinlock-related data is stored inside a memory and the spinlock controller further includes an address register for storing the addresses in the memory where the spinlock-related data are stored.

19. The synchronous apparatus of claim 18, wherein the memory is either an internal memory included within the spinlock controller or is an independent external memory outside the spinlock controller.
